(19) United States
(12) Patent Application Publication
(10) Pub. No.: US 2011/0128193 A1
(43) Pub. Date: Jun. 2, 2011

(54) CARD DEVICE FOR WIRELESS COMMUNICATION

(75) Inventors: SHOGO ARIMURA, Tokyo (JP); Yuji Machida, Tokyo (JP)

(73) Assignee: MITSUMI ELECTRIC CO., LTD., Tokyo (JP)

(21) Appl. No.: 12/957,452

(22) Filed: Dec. 1, 2010

(30) Foreign Application Priority Data
Dec. 2, 2009 (JP) 2009-274975

(51) Int. Cl. H01Q 1/24

(52) U.S. Cl. 343/702

(57) ABSTRACT

A card device for wireless communication which is to be attached to a mobile communication terminal includes a card substrate, a parasitic antenna element for transmission and reception formed on a first surface of the card substrate, and a feed antenna element for transmission and reception formed on a second surface of the card substrate opposite the first surface of the card substrate, wherein the parasitic antenna element and the feed antenna element have substantially the same shape, and are arranged to substantially completely overlap each other across the card substrate.

### BACKGROUND OF THE INVENTION

1. Field of the Invention

The disclosures herein generally relate to card devices, and particularly relate to a card device for wireless communication attached to a mobile communication terminal.

2. Description of the Related Art

Mobile communication terminals such as portable telephones or the like are typically provided with wireless communication functions such as an infrared communication system, a Bluetooth (registered trademark) system, or the like for data transfer at close range. It is also expected to provide mobile communication terminals with a wireless LAN function for data transfer at middle range.

For the purpose of adding a wireless LAN function, a wireless LAN card may be provided that is a card device such as a micro SD card on which a wireless LAN circuit block inclusive of an antenna is mounted. This LAN card is then attached to a mobile communication terminal.

Japanese Patent Application Publication 2001-326521, for example, discloses forming on a substrate surface a driven pattern that is an inverted F-shape antenna pattern comprised of a feed conductive pattern connected to a feed transmission line and a ground conductive pattern connected to a ground conductive part. In this configuration, further, an inverted L-shape antenna pattern comprised of a ground conductive pattern connected to a ground conductive part formed on the back surface of the substrate is formed as a parasitic antenna element on the back surface of the substrate.

Moreover, Japanese Patent Application Publication 2002-76735, for example, discloses forming a driven pattern that is an inverted F-shape antenna pattern comprised of a feed conductive pattern connected to a feed transmission line formed on a substrate surface and a ground conductive pattern connected to a ground conductive part formed on the same substrate surface.

FIG. 9 is a plan view of an example of a micro SD card on which a wireless LAN circuit block inclusive of an antenna is mounted. A micro SD card 1 is 11 mm×16 mm in size. A hatched area 2 on which an antenna is mounted is 11 mm×5 mm in size.

The wireless LAN defined by the wireless LAN standard IEEE802.11b/g uses a frequency range of 2.4 GHz. With this frequency range, a ¼-wavelength monopole antenna, which is a basic antenna as illustrated in FIG. 10A, ends up having an entire length of 30 mm. This exceeds the size of the provided antenna mount area. An inverted L-shape antenna or inverted F-shape antenna, which is used for the purpose of achieving a smaller height based on the monopole antenna, may also have substantially the same size.

A meander line antenna as illustrated in FIG. 10B may be used for the purpose of achieving smaller height and smaller size. This antenna is formed by bending a monopole antenna into a crank shape. The meander line antenna provides a longer line length compared with a monopole antenna having the same height, thereby providing a lower resonance point.

Such a meander line antenna may be utilized as an antenna that provides a sufficient line length in the antenna mount area provided on a micro SD card. In such a case, the frequency range used in the 2.4-GHz wireless LAN is 2412 to 2484 MHz. It is preferable for the VSWR (i.e., voltage standing wave ratio) to be no greater than 3.0 in this frequency range.

Under some circumstances, the resonance point of the meander line antenna may be shifted due to surrounding conditions such as the provision of resin or metal at close range. When this happens, the condition of VSWR being no greater than 3.0 in the frequency range of 2412 to 2484 MHz may not be satisfied.

Accordingly, it may be preferable to provide a card device that satisfies desired antenna sensitivity in the frequency range used by a wireless LAN system.

### SUMMARY OF THE INVENTION

According to one embodiment, a card device for wireless communication which is to be attached to a mobile communication terminal includes a card substrate, a parasitic antenna element for transmission and reception formed on a first surface of the card substrate, and a feed antenna element for transmission and reception formed on a second surface of the card substrate opposite the first surface of the card substrate, wherein the parasitic antenna element and the feed antenna element have substantially the same shape, and are arranged to substantially completely overlap each other across the card substrate.

According to one embodiment, a mobile communication terminal apparatus includes a card-device connector, a card device for wireless communication that is detachably attached to the card-device connector, and a control unit to control the card device, wherein the card device includes a card substrate, a parasitic antenna element for transmission and reception formed on a first surface of the card substrate, and a feed antenna element for transmission and reception formed on a second surface of the card substrate opposite the first surface of the card substrate, wherein the parasitic antenna element and the feed antenna element have substantially the same shape, and are arranged to substantially completely overlap each other across the card substrate.

According to at least one embodiment, desired antenna sensitivity is satisfied in the frequency range used by a wireless LAN system.

### BRIEF DESCRIPTION OF THE DRAWINGS

Other objects and further features of the present invention will be apparent from the following detailed description when read in conjunction with the accompanying drawings, in which:

FIGS. 1A and 1B are plan views of a mobile communication terminal and a wireless LAN card, respectively;

FIG. 2 is a drawing illustrating a schematic configuration of the mobile communication terminal and the wireless LAN card;

FIG. 3 is a block diagram illustrating the configuration of the wireless LAN card;

FIG. 4 is a plan view illustrating an embodiment of the wireless LAN card;

FIG. 5 is a back view of the embodiment of the wireless LAN card;

FIG. 6 is a cross-sectional view of the embodiment of the wireless LAN card;

FIG. 7 is a drawing illustrating the frequency-VSWR characteristics of a meander line antenna;

FIG. 8 is a drawing illustrating a circuit arrangement on the wireless LAN card;

FIG. 9 is a plan view illustrating an example of a micro SD card; and

FIGS. 10A and 10B are drawings illustrating a ¼-wavelength monopole antenna and a meander line antenna, respectively.

### DESCRIPTION OF THE PREFERRED EMBODIMENTS

In the following, embodiments of the present invention will be described with reference to the accompanying drawings. Throughout the drawings, the same elements are referred to by the same numerals.

<Plan View of Mobile Communication Terminal and Wireless LAN Card>

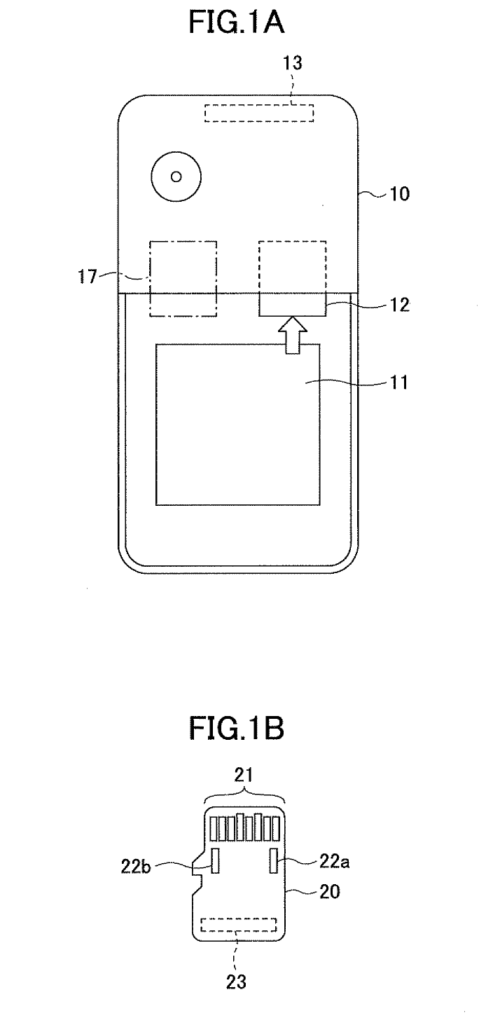

FIGS. 1A and 1B are plan views of a mobile communication terminal and a wireless LAN card, respectively. FIG. 1A is a plan view illustrating an embodiment of a mobile communication terminal. What is illustrated is a mobile communication terminal 10 whose back cover is removed. In the mobile communication terminal 10, a card-device connector 12 is provided in the vicinity of a battery pack 11. The wireless LAN card illustrated in FIG. 1B is inserted in a direction shown by an arrow, and is mounted as a card device in the card-device connector 12. This LAN card is readily removable.

The mobile communication terminal 10 is provided with an antenna 13 operating in a 2.4-GHz frequency range for a Bluetooth (registered trademark) communications system. Other antennas such as an antenna for mobile communication, an antenna for one-segment terrestrial digital broadcasting, and the like in addition to the antenna 13 may be provided in the mobile communication terminal 10.

FIG. 1B is a plan view illustrating an embodiment of a wireless LAN card serving as a card device. In this example, a wireless LAN card 20 is a micro SD card. The wireless LAN card 20 has the 8 standard pins of the micro SD card, and also has two pins 22a and 22b. The pins 21 include a power supply pin, a ground pin, four data pins, a clock pin, and a command pin. The pin 22a is a ground terminal, and the pin 22b is an antenna terminal. The mobile communication terminal 20 is provided with an antenna 23 operating in a 2.4-GHz frequency range for wireless LAN communication.

The wireless LAN defined by the wireless LAN standard IEEE802.11b/g uses a 2.4-GHz frequency range, and the Bluetooth (registered trademark) system also uses the same 2.4-GHz frequency range.

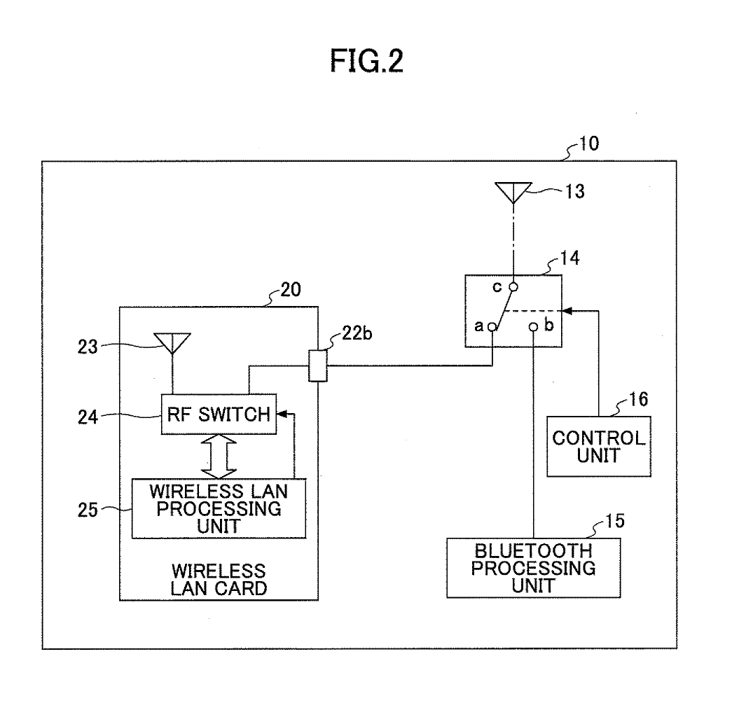

FIG. 2 is a drawing illustrating a schematic configuration of the mobile communication terminal and the wireless LAN card. In the wireless LAN card 20 illustrated in FIG. 2, the antenna 23 and the antenna terminal 22b are connected to an RF switch 24, which is in turn connected to a wireless LAN processing unit 25. Under the control of the wireless LAN processing unit 25, the RF switch 24 couples a selected one of the antenna 23 and the antenna terminal 22b to the wireless LAN processing unit 25.

The antenna terminal 22b of the wireless LAN card 20 is connected to a terminal “a” of an RF switch 14 in the mobile communication terminal 10. A terminal “b” of the RF switch 14 is connected to a Bluetooth processing unit 15. A terminal “c” of the RF switch 14 is connected to the antenna 13.

A control unit 16 for controlling the mobile communication terminal 10 establishes a coupling between the terminals “b” and “c” of the RF switch 14 upon user selection of a Bluetooth mode, thereby connecting the antenna 13 to the Bluetooth processing unit 15. The control unit 16 establishes a coupling between the terminals “a” and “c” of the RF switch 14 upon user selection of a wireless LAN mode, thereby connecting the antenna 13 to the RF switch 24 through the antenna terminal 22b. It may be noted that the wireless LAN processing unit 25 is connected to the control unit 16 of the mobile communication terminal 10 through the pins 21 (FIG. 1B).

The wireless LAN card 20 may be configured such that the antenna terminal 22b and the RF switch 24 are removed, and such that the antenna 23 is directly connected to the wireless LAN processing unit 25. In this case, the mobile communication terminal 10 may be configured such that the antenna 13 is directly connected to the Bluetooth processing unit 15, or such that the antenna 13, the RF switch 14, and the Bluetooth processing unit 15 are removed.

<Configuration of Wireless LAN Card>

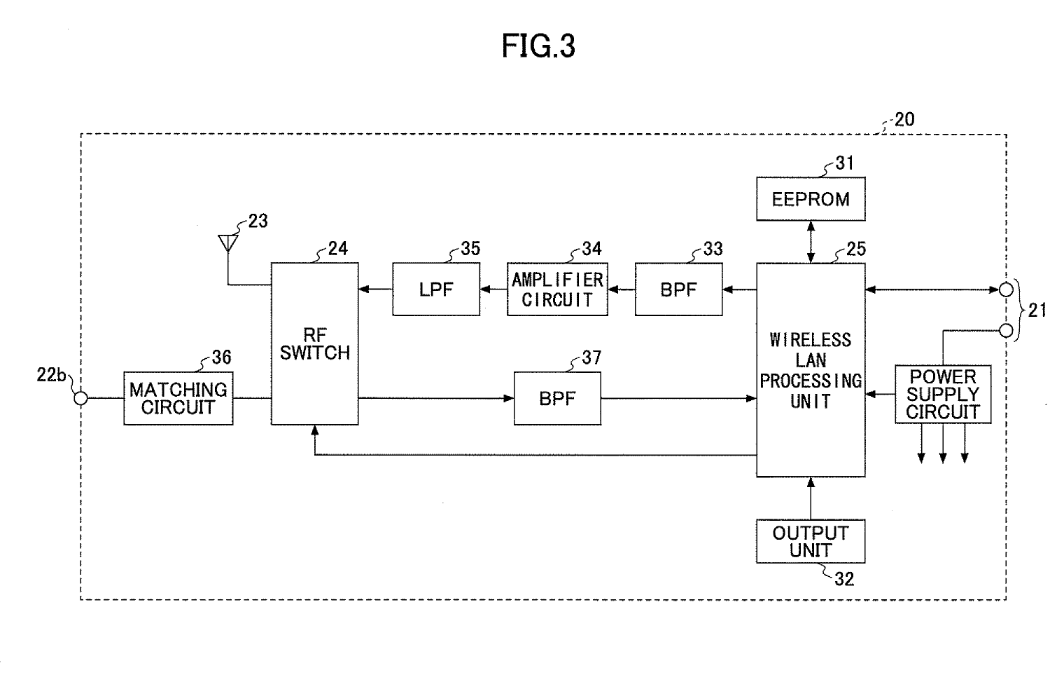

FIG. 3 is a block diagram illustrating the configuration of the wireless LAN card. In FIG. 3, the wireless LAN processing unit 25 includes a microprocessor, which is connected to an EEPROM 31 that the microprocessor uses as a memory device. The wireless LAN processing unit 25 receives a clock signal from an oscillating circuit 32. Upon receiving an indication of a wireless LAN mode from the control unit 16 of the mobile communication terminal 10 through the pins 21, the wireless LAN processing unit 25 performs RF (i.e., high frequency) signal processing, baseband processing, MAC processing, and so on with respect to transmission signals or received signals. The wireless LAN processing unit 25 controls the switching operation of the RF switch 24.

Transmission data supplied from the control unit 16 of the mobile communication terminal 10 or the like through the pins 21 are subjected to MAC processing, baseband processing, and RF processing by the wireless LAN processing unit 25, and are then processed by a band pass filter (BPF) 33 for limiting a frequency band for provision to an amplifier circuit 34. The transmission signals amplified by the amplifier circuit 34 are processed by a low pass filter (LPF) 35 for removing unneeded frequency components for provision to the RF switch 24, thereby being transmitted from either the antenna 23 or the antenna 13, whichever is selected by the RF switch 24.

A matching circuit 36 is provided between the RF switch 24 and the antenna terminal 22b which is connected to the antenna 13 of the mobile communication terminal 10. The matching circuit 36 may include two series-connected capacitors disposed between the antenna terminal 22b and the RF switch 24 and an inductor connecting between the ground and the joining point between the two capacitors. The matching circuit 36 performs impedance matching between the RF switch 14 and the RF switch 24.

One of a signal received by the antenna 13 and a signal received by the antenna 23 is selected by the RF switch 24, and is then processed by a band pass filter 37 for limiting a frequency band for provision to the wireless LAN processing unit 25. The received signal is subjected to RF signal processing, baseband processing, and MAC processing by the wireless LAN processing unit 25, and is then supplied to the control unit 16 of the mobile communication terminal 10 or the like through the pins 21.

<Antenna of Wireless LAN Card>

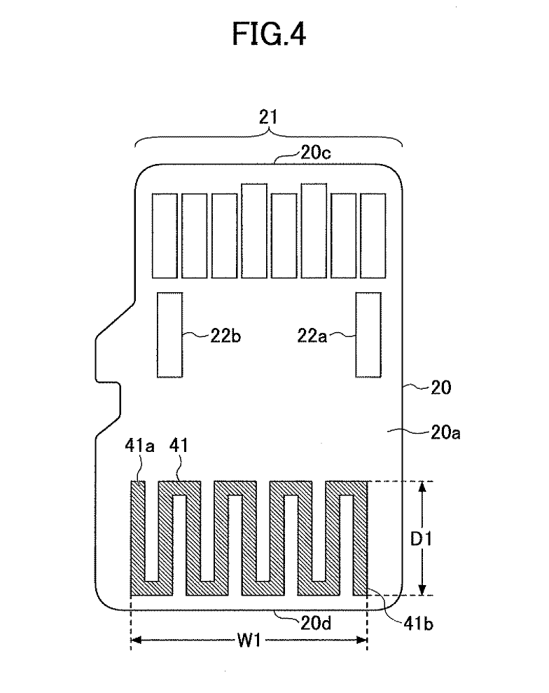

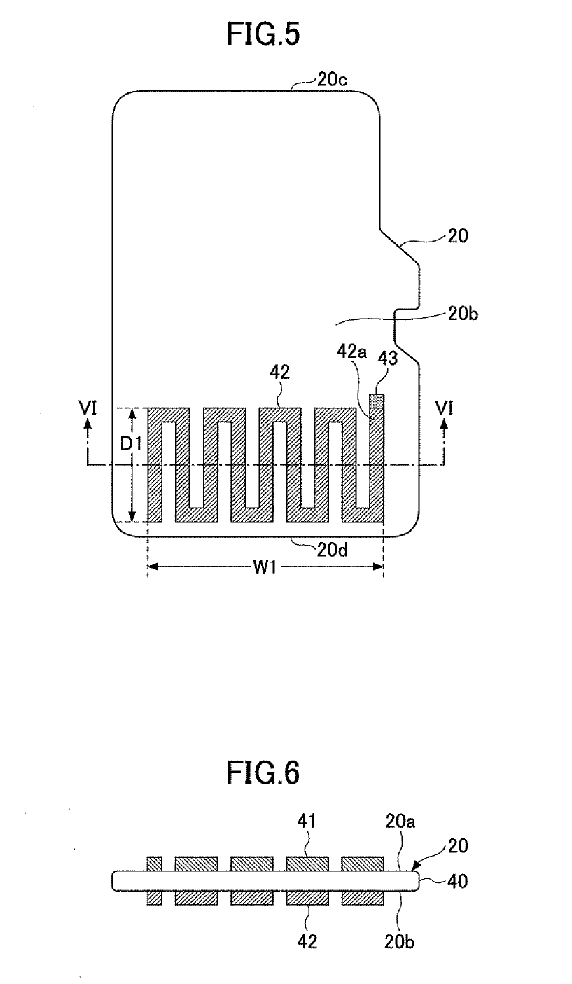

FIG. 4 is a plan view illustrating an embodiment of the wireless LAN card 20. FIG. 5 is a back view of the embodiment of the wireless LAN card 20. FIG. 6 is a cross-sectional view of the embodiment of the wireless LAN card 20 taken along a line VI-VI shown in FIG. 5. In this example, the surface of the wireless LAN card 20 on which the pins 21, 22a and 22b are disposed is referred to as a front surface 20a, and the opposite surface is referred to as a back surface 20b.

In FIG. 4 and FIG. 6, the front surface 20a of the wireless LAN card 20 has a meander line antenna 41 disposed thereon serving as a parasitic antenna element. The meander line antenna 41 is situated along a side 20d that is opposite a side 20c on which the pins 21 are situated. The meander line antenna 41 is formed by applying a conductive material such as metal in crank form on the front surface 20a. The meander line antenna 41 is accommodated within an area having a vertical width D1 (e.g., 4 mm) and a horizontal width W1 (e.g., 8.5 mm). One end 41a of the meander line antenna 41 is not directly connected to the RF switch 24.

In FIG. 5 and FIG. 6, a meander line antenna 42 serving as a feed antenna element is disposed on the back surface 20b of the wireless LAN card 20. The meander line antenna 42 is formed by applying a conductive material such as metal in crank form on the back surface 20b. The meander line antenna 42 is accommodated within an area having a vertical width D1 (e.g., 4 mm) and a horizontal width W1 (e.g., 8.5 mm). The meander line antenna 41 and the meander line antenna 42 are arranged to overlap each other across a card substrate 40 of the wireless LAN card 20. Preferably, the meander line antenna 41 and the meander line antenna 42 may have substantially the same shape, and may be arranged to substantially completely overlap each other across the card substrate 40 of the wireless LAN card 20. One end 42a of the meander line antenna 42 is directly connected to the RF switch 24 through a feed point 43.

The thickness of the insulating card substrate 40 may be 0.2 mm more or less, for example. The meander line antennas 41 and 42 have such a shape that they overlap each other substantially completely. Because of this, the meander line antenna 41 and the meander line antenna 42 are capacitively coupled in high frequency range. The capacitively-coupled meander line antennas 41 and 42 together constitute the antenna 23.

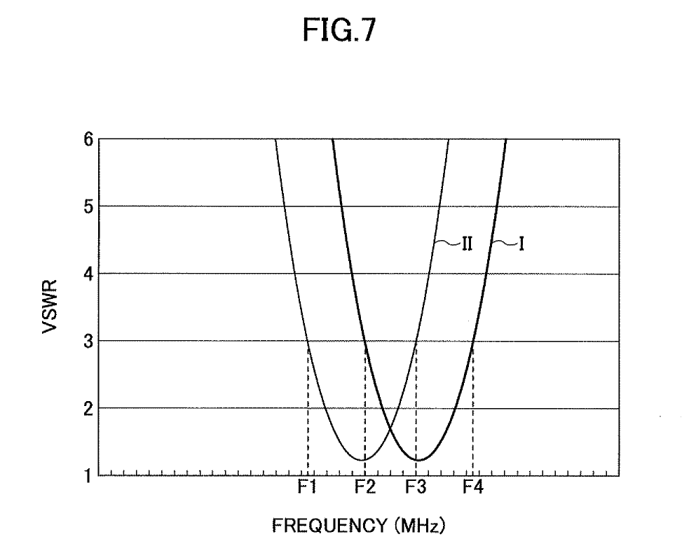

The meander line antenna 42 serving as a feed antenna element has a VSWR of 3.0 or lower between a frequency F2 (e.g., 2430 MHz) and a frequency F4 (e.g., 2490 MHz) as illustrated by a solid curved line I in FIG. 7. The meander line antenna 41 serving as a parasitic antenna element is capacitively coupled to the meander line antenna 42. With this arrangement, the resonance point of the meander line antenna 41 becomes lower than the resonance point of the meander line antenna 42. Accordingly, the meander line antenna 41 has a VSWR of 3.0 or lower between a frequency F1 (e.g., 2410 MHz) and a frequency F3 (e.g., 2470 MHz) as illustrated by a solid curved line II in FIG. 7.

As a result, the antenna 23 has frequency-VSWR characteristics obtained by combining the solid curved line I and the solid curved line II to become a wideband antenna, which has a VSWR of 3.0 or lower between the frequency F1 and the frequency F4. With this arrangement, even if the resonance point of the meander line antenna 42 is shifted due to its close proximity to resin or metal disposed in the surrounding area, the 3.0 or lower VSWR is maintained in the frequency range of 2412 to 2484 MHz.

The meander line antennas 41 and 42 having substantially the same shape are formed on the front surface 20a and back surface 20b of the wireless LAN card 20, respectively, such that the meander line antennas 41 and 42 substantially completely overlap each other. Due to this, the area size used for the antenna 23 on the wireless LAN card 20 is equal to the area size for one antenna, which increases the range of choice in antenna arrangement.

The arrangement may be modified such that the meander line antenna 42 serving as a feed antenna element is disposed on the front surface 20a of the wireless LAN card 20, and the meander line antenna 41 serving as a parasitic antenna element is disposed on the back surface 20b of the wireless LAN card 20. In this case, the feed point 43 of the meander line antenna 42 and the RF switch 24 are connected to each other through a through hole that runs through the card substrate.

In the embodiment described above, the meander line antennas 42 and 41 have such a shape that they substantially completely overlap each other. In this arrangement, one end 41b of the meander line antenna 41 may be shortened or prolonged to adjust the frequency and VSWR characteristics of the meander line antenna 41.

The expression that the meander line antenna 41 and the meander line antenna 42 have substantially the same shape means that the width of the antenna line as well as the entire shape and size of the crank shape are substantially the same, except for manufacturing error, between these two antennas, except at the ends of the antennas. Further, the expression that the meander line antenna 41 and the meander line antenna 42 are arranged to substantially completely overlap each other means that these two antennas overlap each other without any uncovered excess or remainder excluding an uncovered excess or remainder caused by alignment error, except at the ends of the antennas. Namely, the meander line antenna 41 and the meander line antenna 42 overlap each other without any part of one antenna being left uncovered by the other excluding an uncovered part caused by alignment error, except at the ends of the antennas. Here, the phrase “except at the ends of the antennas” means that the end 41b of the meander line antenna 41, for example, may be formed shorter or longer than the matching end of the meander line antenna 42 as previously described.

<Circuit Arrangement of Wireless LAN Card>

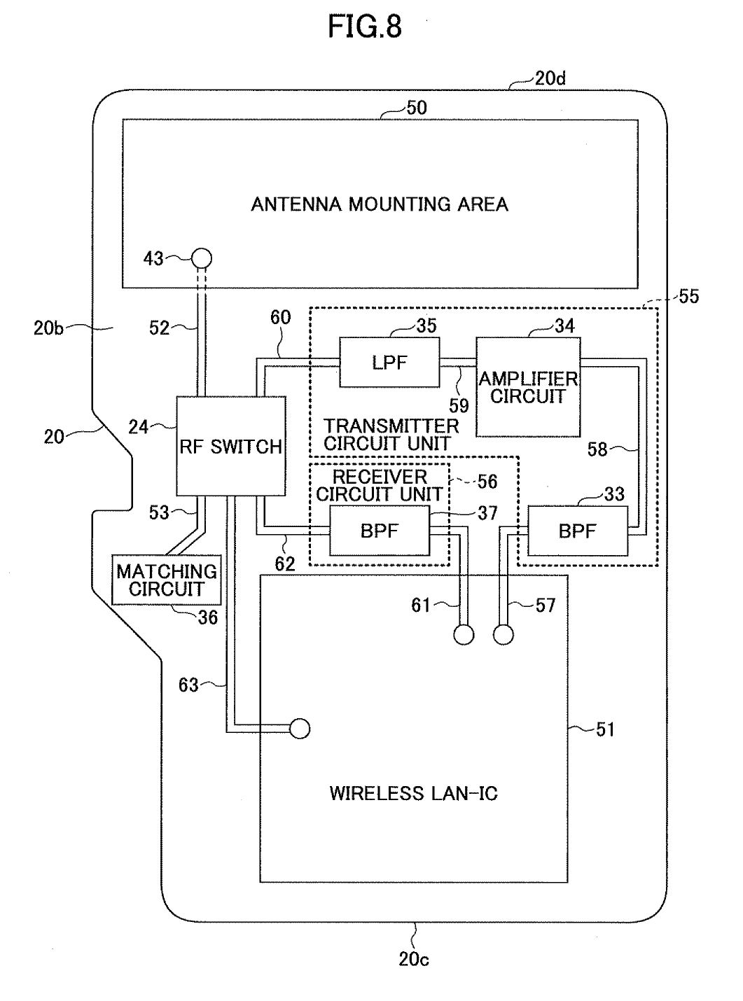

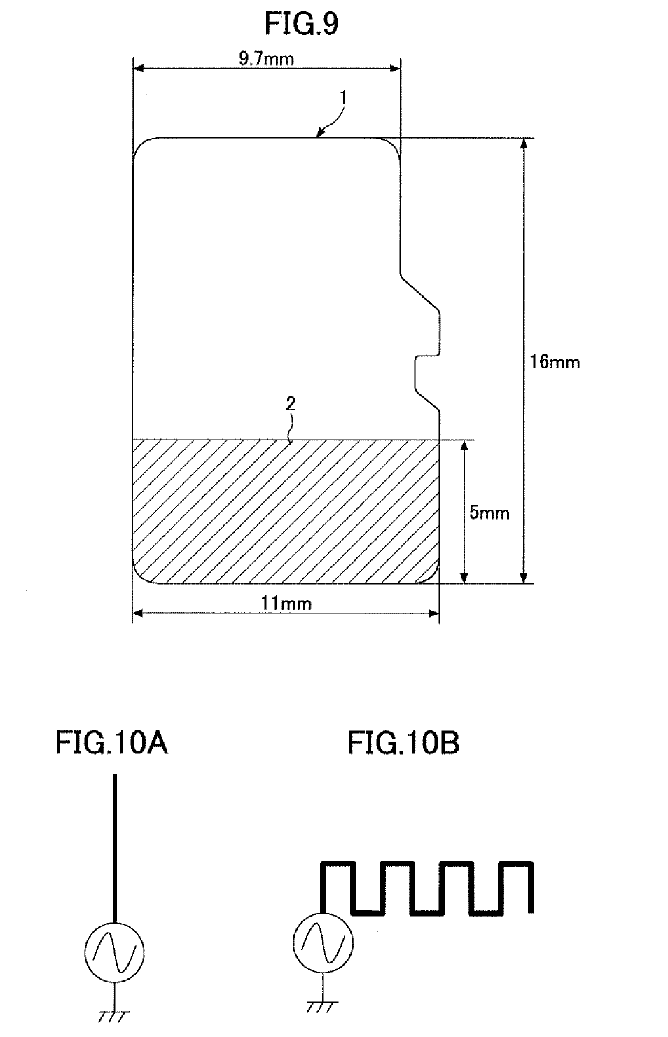

FIG. 8 is a drawing illustrating a circuit arrangement on the wireless LAN card. The meander line antenna 42 is formed in an antenna mounting area 50 on the back surface 20b of the wireless LAN card 20. A wireless LAN-IC 51 is disposed along the side 20c opposite the side 20d along with the meander line antenna 42 is formed. The wireless LAN-IC 51 is an integrated circuit by which the wireless LAN processing unit 25 is implemented.

The RF switch 24 is arranged on the left-hand side of FIG. 8 between the antenna mounting area 50 and the wireless LAN-IC 51. An interconnection line 52 extends from the RF switch 24 to the feed point 43 of the antenna mounting area 50. An interconnection line 53 extending from the RF switch 24 toward the lower part of FIG. 8 is connected to the matching circuit 36. A through hole (not shown) that runs through the card substrate 40 is provided in the matching circuit 36. The matching circuit 36 is connected to the antenna terminal 22b situated on the front surface 20a of the wireless LAN card 20.

A transmitter circuit unit 55 and a receiver circuit unit 56 are disposed at the center and left-hand side of FIG. 8 between the antenna mounting area 50 and the wireless LAN-IC 51. The transmitter circuit unit 55 includes the band pass filter 33, the amplifier circuit 34, and the low pass filter 35. An interconnection line 57 connects between the wireless LAN-IC 51 and the band bass filter 33, and an interconnection line 58 connects between the band pass filter 33 and the amplifier circuit 34. Further, an interconnection line 59 connects between the amplifier circuit 34 and the low pass filter 35, and an interconnection line 60 connects between the low pass filter 35 and the RF switch 24.

The receiver circuit unit 56 includes the band bass filter 37. An interconnection line 61 connects between the wireless LAN-IC 51 and the band bass filter 37. Also, an interconnection line 62 connects between the band bass filter 37 and the RF switch 24. Further, a switch control line 63 connects between the wireless LAN-IC 51 and the RF switch 24.

It may be noted that a card-device connector 17 may be additionally provided in the mobile communication terminal 10 as illustrated by chain lines in FIG. 1A, in addition to the card-device connector 12. A micro-SD memory may be attached to this card-device connector 17. In this manner, the above-described embodiments are not a limiting example.

Further, the present invention is not limited to these embodiments, but various variations and modifications may be made without departing from the scope of the present invention.

The present application is based on Japanese priority application No. 2009-274975 filed on Dec. 2, 2009, with the Japanese Patent Office, the entire contents of which are hereby incorporated by reference.

What is claimed is:

1. A card device for wireless communication which is to be attached to a mobile communication terminal, comprising:
a card substrate;
a parasitic antenna element for transmission and reception formed on a first surface of the card substrate; and
a feed antenna element for transmission and reception formed on a second surface of the card substrate opposite the first surface of the card substrate,
wherein the parasitic antenna element and the feed antenna element have substantially the same shape, and are arranged to substantially completely overlap each other across the card substrate.

2. The card device as claimed in claim 1, wherein each of the parasitic antenna element and the feed antenna element is a meander line antenna.

3. The card device as claimed in claim 2, wherein a signal frequency band transmitted and received by the parasitic antenna element and the feed antenna element is a 2.4-GHz frequency range.

4. A mobile communication terminal apparatus, comprising:
a card-device connector;
a card device for wireless communication that is detachably attached to the card-device connector; and
a control unit to control the card device,
wherein the card device includes:
a card substrate;
a parasitic antenna element for transmission and reception formed on a first surface of the card substrate; and
a feed antenna element for transmission and reception formed on a second surface of the card substrate opposite the first surface of the card substrate,
wherein the parasitic antenna element and the feed antenna element have substantially the same shape, and are arranged to substantially completely overlap each other across the card substrate.

5. A card device for wireless communication which is to be attached to a mobile communication terminal, comprising:
a card substrate;
a parasitic antenna element for transmission and reception formed on a first surface of the card substrate; and
a feed antenna element for transmission and reception formed on a second surface of the card substrate opposite the first surface of the card substrate,
wherein the parasitic antenna element and the feed antenna element are arranged to overlap each other across the card substrate.
